(19) United States
(12) Patent Application Publication
(10) Pub. No.: US 2018/0217563 A1
(43) Pub. Date: Aug. 2, 2018

(54) TIMEPIECE AND CONTROL METHOD OF TIMEPIECE

(71) Applicant: Seiko Instruments Inc., Chiba-shi (JP)

(72) Inventor: Tomohiro IHASHI, Chiba-shi (JP)

(21) Appl. No.: 15/877,827

(22) Filed: Jan. 23, 2018

(30) Foreign Application Priority Data
Jan. 30, 2017 (JP) 2017-014730

(51) Int. Cl. G04G 21/04

(52) U.S. Cl. CPC G04G 21/04; G04C 3/14

(57) ABSTRACT

A timepiece includes a communication unit that controls communication with a communication device by using a periodic communication radio wave, and a control unit that controls a hand operation of an indicating hand driven by a motor. The control unit sets a hand operation permission period during which the hand operation of the indicating hand is permitted starting from communication timing of the communication radio wave.

### RELATED APPLICATIONS

This application claims priority under 35 U.S.C. § 119 to Japanese Patent Application No. 2017-014730 filed on Jan. 30, 2017, the entire content of which is hereby incorporated by reference.

### BACKGROUND OF THE INVENTION

### Field of the Invention

The present invention relates to a timepiece and a control method of a timepiece.

### Background Art

In recent years, a timepiece has been proposed which communicates with a communication device such as smartphone using wireless communication. In this timepiece, an indicating hand is driven in response to the communication with the communication device. However, a timepiece such as a wristwatch has a limitation in size, so that power supplied from a power source is limited. Accordingly the communication and motor driving may be less likely to be simultaneously performed.

In order to solve this problem, a technique has been proposed in which communication period is controlled during the motor driving so that the period of the motor driving and the period of the communication do not overlap each other (for example, refer to JP-A-2011-33430).

### SUMMARY OF THE INVENTION

In order to maintain a connection state of the communication between a timepiece and an external device, the communication needs to be performed every predetermined time points. Therefore, if the communication period has to be adjusted in such the technique disclosed in JP-A-2011-33430, the technique needs a complicated process such a process for varying a communication interval between the two of the every predetermined time points.

The present invention has an object thereof that is to provide a timepiece and a control method of a timepiece in which a hand operation of an indicating hand can be performed even during communication state.

According to an aspect of the present invention, there is provided a timepiece (100) including a communication unit (wireless communication control unit 111) that controls communication with a communication device by using a periodic communication radio wave, and a control unit (101) that controls a hand operation of an indicating hand (120) driven by a motor (122). The control unit sets a hand operation permission period during which the hand operation of the indicating hand is permitted starting from communication timing of the communication radio wave.

In addition, in the timepiece according to the aspect of the present invention, the communication unit may output a radio communication completion signal indicating that the communication timing of the communication radio wave is completed. The control unit may set the hand operation permission period when receiving the radio communication completion signal, and may drive the motor during the hand operation permission period.

In addition, in the timepiece according to the aspect of the present invention, the hand operation permission period may be set as a first permission period (T1) in a case where the communication timing of the communication radio wave is a first period (for example, a period in an advertisement state). The hand operation permission period may be set as a second permission period (T2) shorter than the first permission period in a case where the communication timing of the communication radio wave is a second period (for example, a period in a connection state) shorter than the first period.

In addition, in the timepiece according to the aspect of the present invention, the communication unit may detect at least one state of communication states such as a state of searching for the communication device, a state of performing a connection process for communication with the communication device, and a state of enabling data communication with the communication device. The control unit may change the hand operation permission period in response to the communication state detected by the communication unit.

In addition, in the timepiece according to the aspect of the present invention, the control unit may not set the hand operation permission period in the state of performing the connection process for communication with the communication device.

In addition, in the timepiece according to the aspect of the present invention, the communication unit may not output the radio communication completion signal in the state of performing the connection process for communication with the communication device.

In addition, in the timepiece according to the aspect of the present invention, when there is a hand operation request for requesting the hand operation of the indicating hand, the control unit may determine whether or not the requesting time is the hand operation permission period. In a case where the requesting time is the hand operation permission period, the control unit may perform control so that the motor is driven in response to the hand operation request. In a case where the requesting time is not the hand operation permission period, the control unit may perform control so that the motor is not driven in response to the hand operation request.

In addition, in the timepiece according to the aspect of the present invention, when there is a hand operation request for requesting the hand operation of the indicating hand, the control unit may determine whether or not the requesting time is the hand operation permission period. In a case where the requesting time is the hand operation permission period, the control unit may perform control so that the motor is driven in response to the hand operation request. In a case where the requesting time is not the hand operation permission period, after the elapse of time correction, the control unit may determine whether or not the requesting time is the hand operation permission period.

In addition, in the timepiece according to the aspect of the present invention, during the hand operation permission period, the control unit may cause the indicating hand to perform the hand operation so that as a communication state, the communication unit uses a motion of the indicating hand to notify at least one state among a state of searching for the communication device, a state of performing a connection process for communication with the communication device, and a state of enabling data communication with the communication device.

In addition, in the timepiece according to the aspect of the present invention, when data is received in the state of enabling data communication with the communication device, during the hand operation permission period, the control unit may cause the indicating hand to perform the hand operation as many as the predetermined number of steps so that a communication progress status of the data is notified using the hand operation performed as many as the predetermined number of steps which reflects the communication progress status of the data.

In addition, the timepiece according to the aspect of the present invention may further include an operation unit that selects any one function among a time display function, a timer function, an alarm function, and a stopwatch function. In a case where the indicating hand is driven based on the function selected by operating the operation unit, during the hand operation permission period, the control unit may cause the indicating hand to perform the hand operation so that a position of the indicating hand is updated to an updated position corresponding to the function.

According to another aspect of the present invention, in order to achieve the above-described object, there is provided a control method of a timepiece which has a control unit for controlling a hand operation of an indicating hand driven by a motor. The control method includes causing a communication unit to control communication with a communication device by using a periodic communication radio wave, causing the communication unit to output a radio communication completion signal indicating that communication timing of the communication radio wave is completed, causing the control unit to set a hand operation permission period during which the hand operation of the indicating hand is permitted starting from the communication timing of the communication radio wave, and causing the control unit to set the hand operation permission period when the radio communication completion signal is received, and to drive the motor during the hand operation permission period.

### BRIEF DESCRIPTION OF THE DRAWINGS

FIG. 1 shows an example of a block diagram of a timepiece system in accordance with a first embodiment.

FIG. 2 shows an example of a timing chart of communication state between a timepiece and a communication device in accordance with the first embodiment.

FIG. 3 shows an example of a flowchart of a main routine processed by a control unit in accordance with the first embodiment.

FIG. 4 shows an example of a flowchart of a hand operation permission setting process during communication in accordance with the first embodiment.

FIG. 5 shows an example of a flowchart of a hand operation process during the communication in accordance with the first embodiment.

FIG. 6 shows an example of a flowchart of a process for completing the communication between the timepiece and the communication device in accordance with the first embodiment.

FIG. 7 shows an example of a flowchart of canceling a hand operation permission process during the communication in accordance with the first embodiment.

FIG. 8 shows an example of a flowchart of generating a hand operation timing process during the communication in accordance with the first embodiment.

FIG. 9 schematically shows a view illustrating an example of an external appearance of a timepiece in accordance with a second embodiment.

FIG. 10 schematically shows a view illustrating a drive example of a second hand in an advertisement state in accordance with the second embodiment.

FIG. 11 schematically shows a view illustrating a drive example of the second hand in a connection state in accordance with the second embodiment.

FIG. 12 shows an example of a flowchart of a main routine of a process performed by a control unit in accordance with the second embodiment.

FIG. 13 shows an example of a flowchart of a hand operation process of the second hand in the advertisement state in accordance with the second embodiment.

FIG. 14 shows a flowchart of a hand operation start process in the connection state in accordance with the second embodiment.

FIG. 15 shows an example of a flowchart of a process when communication is completed in accordance with the second embodiment.

### DETAILED DESCRIPTION OF THE INVENTION

The present disclosure is directed to a timepiece with communication function. As described in more detail below, non-limiting embodiments according to the present invention is described with reference to the drawings.

### First Embodiment

### [Description of Timepiece 100]

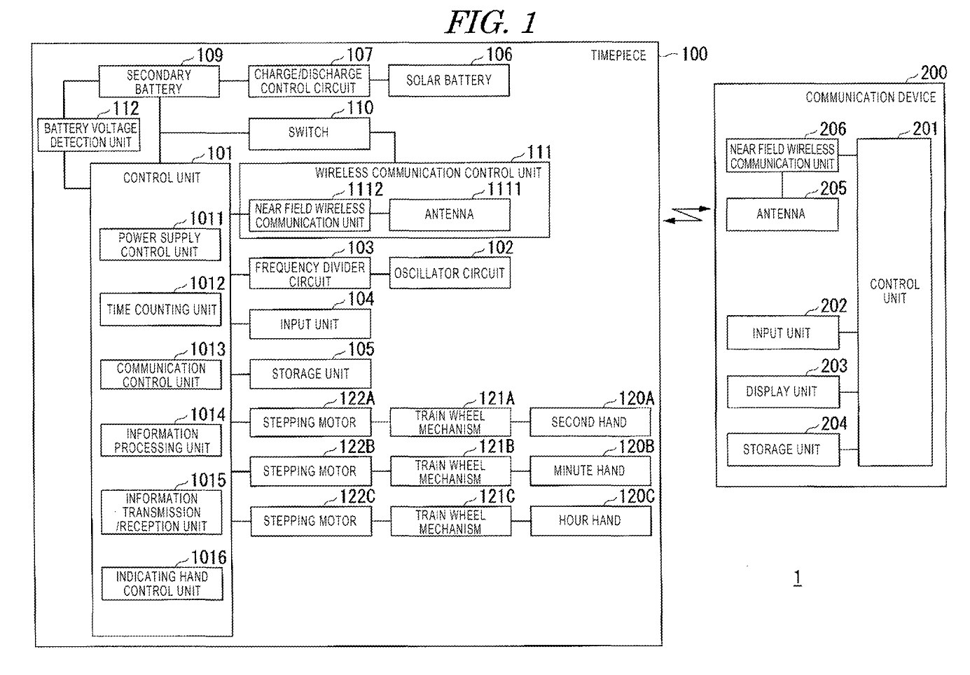

FIG. 1 is a block diagram illustrating a configuration example of a timepiece system 1 according to a first embodiment.

As illustrated in FIG. 1, the timepiece system 1 includes a communication device 200, and a timepiece 100 capable of communication with the communication device 200.

The timepiece 100 includes a control unit 101, an oscillator circuit 102, a frequency divider circuit 103, an input unit 104, a storage unit 105, a solar battery 106, a charge/discharge control circuit 107, a secondary battery 109, a switch 110, a wireless communication control unit 111, a battery voltage detection unit 112, a second hand 120A, a minute hand 120B, an hour hand 120C, a train wheel mechanism 121A, a train wheel mechanism 121B, a train wheel mechanism 121C, a stepping motor 122A, a stepping motor 122B, and a stepping motor 122C.

The timepiece 100 includes a case, a windshield, a dial, a bezel, and a band.

In a case where one of the second hand 120A, the minute hand 120B, and the hour hand 120C is not specified in the present disclosure, they are collectively or at least one of the three hands referred to as an indicating hand 120. In a case where one of the train wheel mechanism 121A, the train wheel mechanism 121B, and the train wheel mechanism 121C is not specified in the present disclosure, they are collectively or at least one of the three hands referred to as a train wheel mechanism 121. In a case where one of the stepping motor 122A, the stepping motor 122B, and the stepping motor 122C is not specified in the present disclosure, they are collectively or at least one of the three hands referred to as a motor 122.

In addition, the control unit 101 includes a power supply control unit 1011, a time counting unit 1012, a communication control unit 1013, an information processing unit 1014, an information transmission/reception unit 1015, and an indicating hand control unit 1016.

In addition, the wireless communication control unit 111 includes an antenna 1111 and a near field wireless communication unit 1112.

The timepiece 100 receives at least information from the communication device 200 via wireless communication, and drives at least the second hand 120A, based on the received information. The timepiece 100 clocks the time, and displays the clocked time by using the second hand 120A, the minute hand 120B, and the hour hand 120C.

For example, the solar battery 106 is a solar panel. The solar battery 106 converts light energy into electric power, and outputs the converted electric power to the charge/discharge control circuit 107.

The charge/discharge control circuit 107 charges the secondary battery 109 with the electric power output by the solar battery 106. The charge/discharge control circuit 107 performs discharge control so as to discharge the electric power or stop charging in a case where a voltage value of the secondary battery 109 is equal to or greater than a predetermined voltage value. The charge/discharge control circuit 107 supplies the electric power stored in the secondary battery 109 to the control unit 101. In accordance with the control unit 101, the charge/discharge control circuit 107 supplies the electric power stored in the secondary battery 109 to the wireless communication control unit 111 when the switch 110 is in a turned-on state.

The secondary battery 109 is a storage battery which stores electric energy generated by the solar battery 106. The secondary battery 109 supplies the stored electric power to the control unit 101 and the wireless communication control unit 111.

One end of the switch 110 is connected to the secondary battery 109, and the other end is connected to the wireless communication control unit 111. The switch 110 is controlled by the power supply control unit 1011.

The battery voltage detection unit 112 detects a voltage value of the secondary battery 109, and outputs information indicating the detected voltage value to the control unit 101.

The electric power is supplied to the wireless communication control unit 111 from the secondary battery 109 in accordance with the control of the power supply control unit 1011. The wireless communication control unit 111 converts data output by the communication control unit 1013 into a transmission signal corresponding to a communication method for communication with the communication device 200, and converts the converted transmission signal to a radio wave. The wireless communication control unit 111 transmits the converted radio wave to the communication device 200. The wireless communication control unit 111 receives the radio wave transmitted by the communication device 200 in accordance with the control of the communication control unit 1013. The wireless communication control unit 111 converts the received radio wave into an electric signal in accordance with the control of the communication control unit 1013, and outputs the converted electric signal as a reception signal to the communication control unit 1013. In the embodiment, signals including a transmission signal and a reception signal are also referred to as a communication radio wave. When data transmission and/or reception are completed, the wireless communication control unit 111 generates a radio communication completion signal indicating that the data transmission and/or reception are completed, and outputs the generated radio communication completion signal to the control unit 101.

The near field wireless communication unit 1112 converts the data output by the communication control unit 1013 into the transmission signal corresponding to a communication method for communication with the communication device 200, and outputs the converted transmission signal to the antenna 1111. The communication method by which the timepiece 100 and the communication device 200 communicate with each other is a communication methods including Wireless Fidelity (Wi-Fi) standards or Bluetooth (registered trademark) Low Energy (LE) (hereinafter, referred to as BLE) standards. In the following description, an example is described in which the communication method uses the BLE. The near field wireless communication unit 1112 outputs the electric signal output by the antenna 1111 as the reception signal to the communication control unit 1013. When the data transmission and reception are completed, the near field wireless communication unit 1112 generates the radio communication completion signal indicating that the data transmission and/or reception are completed, and outputs the generated radio communication completion signal to the communication control unit 1013.

The antenna 1111 converts the transmission signal output by the near field wireless communication unit 1112 into the radio wave, and transmits the converted radio wave. The antenna 1111 converts the received radio wave into the electric signal, and outputs the converted electric signal as the reception signal to the near field wireless communication unit 1112.

For example, the oscillator circuit 102 includes a crystal oscillator. The crystal oscillator is a passive element used to oscillate a first frequency from the mechanical resonance by utilizing the piezoelectric phenomenon of quartz. The oscillation frequency of the crystal oscillator is 32 kHz, for example. The oscillator circuit 102 outputs a clock signal generated by oscillating the crystal oscillator to the frequency divider circuit 103.

The frequency divider circuit 103 divides the clock signal output by the oscillator circuit 102 into a desired frequency, and outputs a frequency-divided reference signal to the control unit 101. The frequency of the reference signal is 64 Hz and 32 Hz, for example.

The input unit 104 is a crown, for example. The input unit 104 detects an operation of a user, and outputs the detected operation result to the control unit 101. The detection result of the crown is output as a rotation angle of the crown. As is described later, in the timepiece 100 according to the present embodiment, operation modes are switched in accordance with the operation of the crown. Here, the operation modes include a time adjustment mode (normal operation mode) and a communication mode for performing communication.

The storage unit 105 stores information or a program required for controlling the timepiece 100. The storage unit 105 stores the time of hand operation permission setting start timing. The storage unit 105 stores a hand operation permission flag. The storage unit 105 stores a hand operation request flag.

For example, the control unit 101 is a central processing unit (CPU), and controls each unit installed in the timepiece 100. The control unit 101 drives each unit by using the electric power output from the secondary battery 109. The control unit 101 clocks the time, and controls the motor 122, based on the clocked result, thereby causing the indicating hand 120 to perform the hand operation. The control unit 101 generates a drive pulse for driving the second hand 120A in response to the information received by the wireless communication control unit 111. The control unit 101 generates a drive pulse for adjusting the time or the date in response to the detection result output by the input unit 104. The control unit 101 outputs the generated drive pulse to the motor 122. In a case where a voltage value detected by the battery voltage detection unit 112 is greater than a predetermined value, the control unit 101 controls the switch 110 to be in a turned-on state. In a case where the voltage value is equal to or smaller than the predetermined value, the control unit 101 controls the switch 110 to be in a turned-off state.

The power supply control unit 1011 controls a turned-on state or a turned-off state of the power supply of the wireless communication control unit 111. Specifically, only when the wireless communication control unit 111 communicates with the communication device 200, the power supply control unit 1011 switches the switch 110 to be in the turned-on state, thereby performing control so that the electric power is supplied from the secondary battery 109 to the wireless communication control unit 111. In addition, when the wireless communication control unit 111 does not communicate with the communication device 200, the power supply control unit 1011 switches the switch 110 to be in the turned-off state, thereby performing control so that the electric power is not supplied from the secondary battery 109 to the wireless communication control unit 111. In addition, the power supply control unit 1011 controls each unit in response to the voltage value of the secondary battery 109 which is detected by the battery voltage detection unit 112. For example, in a case where the voltage value is smaller than the threshold value, the power supply control unit 1011 controls the indicating hand control unit 1016 so as to change an interval of the hand operation.

The time counting unit 1012 includes an internal counter, clocks the current time (hour, minute, and second), based on a reference signal input from the frequency divider circuit 103, and causes the internal counter to hold indicating hand position information indicating the clocked time.

The information processing unit 1014 generates data to be transmitted to the communication device 200, and outputs the generated data to the information transmission/reception unit 1015. The information processing unit 1014 processes the received data output by the information transmission/reception unit 1015. For example, processing the data is extracting a command from received data.

The communication control unit 1013 receives the radio communication completion signal output by the wireless communication control unit 111. When the communication control unit 1013 receives the radio communication completion signal, the communication control unit 1013 causes the storage unit 105 to store the received time. The communication control unit 1013 sets a base point of the hand operation permission period at the timing that the wireless communication control unit 111 outputs the radio communication completion signal. The communication control unit 1013 sets the hand operation permission flag (for example, setting to 1), and causes the storage unit 105 to store the hand operation permission flag. The hand operation permission period represents a period during which the indicating hand 120 is permitted to be driven by the motor 122. The communication control unit 1013 determines whether or not a predetermined time elapses from the stored time in response to the timer operation. When the predetermined time elapses, the communication control unit 1013 resets the hand operation permission flag (for example, setting to 0).

The information transmission/reception unit 1015 outputs the data output by the information processing unit 1014 to the near field wireless communication unit 1112. The information transmission/reception unit 1015 outputs the received data output by the near field wireless communication unit 1112 to the information processing unit 1014.

The indicating hand control unit 1016 generates a hand operation request in response to the counted value of the time counting unit 1012. In a case where the indicating hand control unit 1016 generates the hand operation request during the period in which the hand operation permission flag is not set, the hand operation request flag is set without performing the hand operation request (for example, setting to 1), and causes the storage unit 105 to store the hand operation request flag. The indicating hand control unit 1016 determines whether or not the hand operation permission flag is set in the storage unit 105. The indicating hand control unit 1016 determines whether or not the hand operation request is generated in the period in which the hand operation permission flag is set, or determines whether or not the hand operation request flag is set in the storage unit 105. In a case where the hand operation request is generated or in a case where the hand operation request flag is set, the indicating hand control unit 1016 performs the hand operation request so that the drive pulse is generated and output to the motor 122. The drive pulse is a drive signal which causes the indicating hand 120 to perform one step normal rotation or a drive signal which causes the indicating hand 120 to perform one step reverse rotation.

The stepping motor 122A, the stepping motor 122B, and the stepping motor 122C are respectively stepping motors.

The stepping motor 122A drives the second hand 120A via the train wheel mechanism 121A by using the drive pulse output by the indicating hand control unit 1016. The stepping motor 122B drives the minute hand 120B via the train wheel mechanism 121B by using the drive pulse output by the indicating hand control unit 1016. The stepping motor 122C drives the hour hand 120C via the train wheel mechanism 121C by using the drive pulse output by the indicating hand control unit 1016.

Each of the train wheel mechanism 121A, the train wheel mechanism 121B, and the train wheel mechanism 121C is configured to include at least one gear.

The second hand 120A is a second hand. The minute hand 120B is a minute hand. The hour hand 120C is an hour hand.

### Description of Communication Device

Next, the communication device 200 will be described.

As illustrated in FIG. 1, the communication device 200 includes a control unit 201, an input unit 202, a display unit 203, a storage unit 204, an antenna 205, and a near field wireless communication unit 206.

The communication device 200 is a device having a communication function, for example, such as a smartphone, a tablet terminal, a portable game machine, and a computer. The communication device 200 may include a mechanism capable of communication exchange with a satellite such as a global positioning system (GPS) or a mechanism capable of communication exchange with an external server.

The input unit 202 detects an operation input from a user, and outputs the detected operation result to the control unit 201. For example, the input unit 202 is a touch panel sensor disposed on the display unit 203.

The control unit 201 displays an application on the display unit 203, when the application is activated. The control unit 201 acquires the time via a network in accordance with an instruction of the application, and outputs the acquired current location time serving as transmission information time to the near field wireless communication unit 206. The acquired time may be the time of the current location, and the time of a designated city or country.

The storage unit 204 stores information or a program required for controlling the communication device 200, and an application for generating instructions given to the timepiece 100.

The display unit 203 is a device for displaying information. As an example, the display unit 203 is configured to include a liquid crystal display (LCD) and an organic EL (Electro Luminescence) device. For example, the display unit 203 displays an image of the application in accordance with the control of the control unit 201.

The near field wireless communication unit 206 transmits information to the timepiece 100 via the antenna 205. The near field wireless communication unit 206 generates a transmission signal, based on the transmission information output by the control unit 201, and transmits the generated transmission signal to the timepiece 100 via the antenna 205. The near field wireless communication unit 206 receives the transmission signal transmitted by the timepiece 100 via the antenna 205, extracts information from the received signal, and outputs the extracted information serving as reception information to the control unit 201.

The antenna 205 converts the transmission signal output by the near field wireless communication unit 206 into a radio wave, and transmits the converted radio wave to the timepiece 100.

### [Overview of BLE Communication]

In the following example, an example will be described in which the timepiece 100 and the communication device 200 communicating with each other using a BLE communication method.

In the BLE communication, a device on a service provider side (in the embodiment, the timepiece 100) transmits an advertising packet to the surroundings at a cycle set by the device on the service provider side. The advertising packet includes a universal unique identification (UUID) number including information indicating a service provided by the device, or information for identifying the device.

In order to receive the advertising packet, a device on a service receiver side (in the embodiment, the communication device 200) performs scanning at a cycle set by the device on the service receiver side. When receiving the advertising packet by performing the scanning, the device on the service receiver side analyzes the received advertising packet.

If the device on the service receiver side determines that a transmission source of the advertisement packet is a device which provides the service requested by the host device and permits communication, the device on the service receiver side performs pairing so as to perform a connection process. In this manner, a connection is established between the device on the service provider side and the device on the service receiver side.

Thereafter, the device on the service receiver side receives information until the device on the service receiver side receives a request for disconnecting the communication from the device on the service provider side. When the request for disconnecting the communication is received from the device on the service provider side, the device on the service receiver side completes the communication with the device on the service provider side. Alternatively, if the device on the service receiver side transmits a request for disconnecting the communication and the device on the service provider side receives the request for disconnecting the communication, the power supply to the communication unit is blocked, and the device on the service provider side completes the communication.

### [Example of Communication]

Next, an example of communication between the timepiece 100 and the communication device 200 according to the present embodiment will be described.

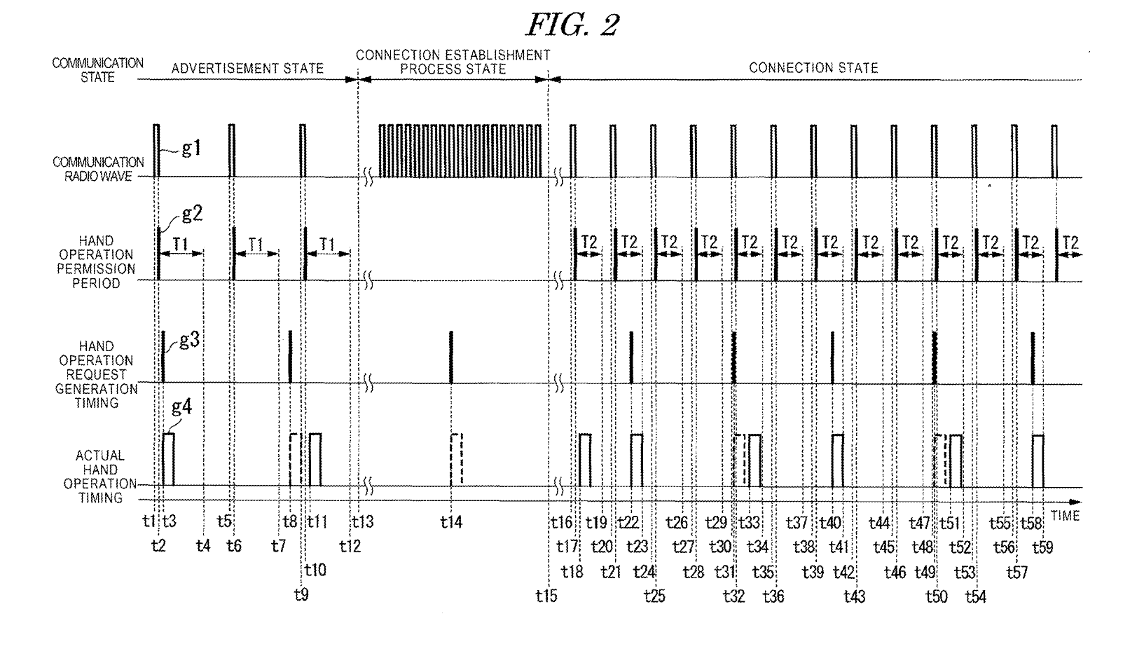

FIG. 2 is a timing chart of the example of communication between the timepiece 100 and the communication device 200 according to the present embodiment.

In FIG. 2, a reference numeral g1 indicates a state where the wireless communication control unit 111 transmits and receives data.

A reference numeral g2 indicates timing at which the communication control unit 1013 receives the communication completion signal output by the wireless communication control unit 111, and the start of the hand operation permission period set from the timing at which the communication completion signal is received.

A reference numeral g3 indicates the hand operation request for the hand operation of each indicating hand 120. The hand operation request is generated by the indicating hand control unit 1016, based on a time clocking or receiving state.

A reference numeral g4 indicates the timing at which the indicating hand control unit 1016 outputs the drive pulse to the motor 122, that is, the timing at which the hand operation is actually performed.

In addition, a period of times t1 to t13 is an advertisement period. During this period, the communication control unit 1013 of the timepiece 100 starts to transmit the advertising packet by controlling the wireless communication control unit 111. In addition, during this period, the control unit 201 of the communication device 200 controls the near field wireless communication unit 206 so as to perform scanning.

A period of times t13 to t15 is a period in a connection establishment process state. During this period, the timepiece 100 and the communication device 200 transmit and receive information for establishing the communication to and from each other.

A period subsequent to time t15 is a period in a connection state. During this period, the timepiece 100 and the communication device 200 transmit and receive the information to and from each other at every predetermined time.

### [Operation in Case of Time Clocking]

First, an operation performed when the time is clocked will be described with reference to FIG. 2.

A user operates the input unit 104 of the timepiece 100 at the time prior to time t1, and selects an operation mode for starting the communication. The power supply control unit 1011 performs control so as to supply the electric power to the wireless communication control unit 111 in response to the detection result detected by the input unit 104. In addition, the user operates the input unit 202 of the communication device 200 so as to select an application. The control unit 201 of the communication device 200 activates the application.

At times t1 to t2, the communication control unit 1013 controls the wireless communication control unit 111 so as to transmit the advertising packet. A communication interval (time t1 and time t5) in the advertisement state is 400 msec, for example. In addition, Time T1 of the hand operation permission period is 390 msec, for example.

At time t2, the near field wireless communication unit 1112 outputs the radio communication completion signal indicating that the communication is completed to the communication control unit 1013.

At time t2, the communication control unit 1013 receives the radio communication completion signal output by the near field wireless communication unit 1112, and causes the storage unit 105 to store the received time as hand operation permission setting start timing. Subsequently, the communication control unit 1013 reads Time T1 of the hand operation permission period used during the advertisement from the storage unit 105, and starts a timer operation. Furthermore, the communication control unit 1013 sets (for example, rewriting to 1) the hand operation permission flag in the storage unit 105. That is, in the embodiment, the communication timing in the advertisement state is the first period (for example, times t1 to t5). During the first period, the communication control unit 1013 sets the hand operation permission period as a first permission period T1.

At time t3, the indicating hand control unit 1016 generates the hand operation request. The timing at which the indicating hand control unit 1016 generates the hand operation request is the timing based on the reference signal (for example, 32 Hz (=approximately 31 msec)). An interval for generating the hand operation request of the hour hand 120C is every 90 seconds, for example. An interval for generating the hand operation request of the minute hand 120B is every 7.5 seconds, for example. An interval for generating the hand operation request of the second hand 120A is every second, for example. Subsequently, the indicating hand control unit 1016 determines whether or not the hand operation permission flag is set. At time t3, the indicating hand control unit 1016 generates the drive pulse since the hand operation permission flag is set at the timing of the hand operation request, and outputs the generated drive pulse to the motor 122. In this manner, when the drive pulse is generated, the indicating hand 120 is driven.

At time t4, the communication control unit 1013 detects that the time T1 of the hand operation permission period is completed in response to the timer operation. Subsequently, the communication control unit 1013 resets the hand operation permission flag.

During a period from times t5 to t7, the communication control unit 1013, the indicating hand control unit 1016, and the wireless communication control unit 111 repeatedly perform the operation at times t1 to t4. During a period of times t6 to t7, the hand operation request is not generated. Accordingly, the indicating hand 120 is not driven.

At time t8, the indicating hand control unit 1016 generates the hand operation request. Subsequently, the indicating hand control unit 1016 determines whether or not the hand operation permission flag is set. The indicating hand control unit 1016 does not generate the drive pulse since the hand operation permission flag is not set at the timing of the hand operation request, and causes the storage unit 105 to store the hand operation request flag indicating that the hand operation request is generated. That is, in the present embodiment, if not the hand operation permission period, the indicating hand control unit 1016 does not drive the indicating hand 120.

During a period of times t9 to t10, the communication control unit 1013, the indicating hand control unit 1016, and the wireless communication control unit 111 repeatedly perform the operation at times t1 to t2.

At time t11, the indicating hand control unit 1016 determines whether or not the hand operation request is generated and whether or not the hand operation request flag is set in the storage unit 105. At time t11, the hand operation permission flag is set at time t8. The timing of time t11 is the hand operation permission period t10 to t12, and is the timing of the reference signal. Therefore, the indicating hand control unit 1016 generates the drive pulse, and outputs the generated drive pulse to the motor 122. That is, at the timing of time t11, the indicating hand control unit 1016 performs the hand operation request generated at time t8. In this way, in the present embodiment, in a case where the hand operation request is generated during a period other than the hand operation permission period, the indicating hand control unit 1016 generates the drive pulse in the subsequent hand operation permission period, and drives indicating hand 120.

During a period of time t13 to t15, the communication control unit 1013 does not set the hand operation permission flag since the communication establishment process is in progress. During a period (period of time t13 to t15) of the connection establishment process state, the control unit 101 performs the communication at a communication interval shorter than a period of times t1 to t13. Therefore, even if the hand operation request is generated, the processing cannot be performed. Accordingly, communication control unit 1013 does not set the hand operation permission flag.

At time t14, the indicating hand control unit 1016 generates the hand operation request. Subsequently, the indicating hand control unit 1016 determines whether or not the hand operation permission flag is set. The indicating hand control unit 1016 does not generate the drive pulse since the hand operation permission flag is not set, and causes the storage unit 105 to store the hand operation request flag indicating that the hand operation request is generated.

In the connection state subsequent to time t16, the communication interval is shorter than that in the advertisement state, and is 150 msec, for example. The information transmitted by the timepiece 100 to the communication device 200 during the connection establishment process includes information indicating this communication interval. That is, in the embodiment, the communication timing in the connection state is the second period (for example, times t17 to t19) which is shorter than the first period. During the second period, the communication control unit 1013 sets the hand operation permission period as the second permission period T2.

In an example of a period of times t16 to t19, the example shows that the hand operation request flag is set in the past.

During the period of times t16 to t17, the control unit 101 and the wireless communication control unit 111 perform data transmission and reception with the communication device 200. Subsequently, at time t17, the near field wireless communication unit 1112 outputs the radio communication completion signal indicating that the communication is completed to the communication control unit 1013.

At time t18, the indicating hand control unit 1016 determines whether or not the hand operation request is generated and whether or not the hand operation request flag is set in the storage unit 105. At time t18, the hand operation permission flag is set at time t14. Therefore, the indicating hand control unit 1016 generates the drive pulse, and outputs the generated drive pulse to the motor 122. The timing of time t18 is a period of the hand operation permission period t17 to t19, and is the timing of the reference signal. That is, at the timing of time t18, the indicating hand control unit 1016 performs the hand operation request generated at time t14.

In an example of a period of times t20 to t23, the example shows that the hand operation request is generated during the hand operation permission period.

During the period of times t20 to t21, the control unit 101 and the wireless communication control unit 111 perform data transmission and reception with the communication device 200.

At time t21, the indicating hand control unit 1016 generates the hand operation request. Subsequently, the indicating hand control unit 1016 determines whether or not the hand operation permission flag is set. The indicating hand control unit 1016 generates the drive pulse since the hand operation permission flag is set, and outputs the generated drive pulse to the motor 122.

At time t23, the communication control unit 1013 detects that Time T2 of the hand operation permission period is completed in response to the timer operation. Subsequently, the communication control unit 1013 resets the hand operation permission flag.

In an example illustrated at times t24 to t26, the example shows that the hand operation request is not generated during the hand operation permission period.

During the period from times t24 to t25, the control unit 101 and the wireless communication control unit 111 perform data transmission and reception with the communication device 200.

At time t26, the communication control unit 1013 detects that Time T2 of the hand operation permission period is completed in response to the timer operation. Subsequently, the communication control unit 1013 resets the hand operation permission flag.

In an example of a period of times t30 to t34, the example shows that the hand operation request is generated during a period while the near field wireless communication unit 1112 performs communication.

During the period of times t30 to t32, the control unit 101 and the wireless communication control unit 111 perform data transmission and reception with the communication device 200.

At time t31, the indicating hand control unit 1016 generates the hand operation request. Subsequently, the indicating hand control unit 1016 determines whether or not the hand operation permission flag is set. The indicating hand control unit 1016 causes the storage unit 105 to store the hand operation request flag since the hand operation permission flag is not set.

At time t32, the near field wireless communication unit 1112 outputs the radio communication completion signal indicating that the communication is completed to the communication control unit 1013.

At time t33, the indicating hand control unit 1016 determines whether or not the hand operation request is generated and whether or not the hand operation request flag is set in the storage unit 105. At time t33, the hand operation permission flag is set at time t30. Therefore, the indicating hand control unit 1016 generates the drive pulse, and outputs the generated drive pulse to the motor 122. The timing of time t33 is the period of the hand operation permission period t32 to t34, and is the timing of the reference signal.

At time t34, the communication control unit 1013 detects that Time T2 of the hand operation permission period is completed in response to the timer operation. Subsequently, the communication control unit 1013 resets the hand operation permission flag.

That is, at the timing of time t33, the indicating hand control unit 1016 performs the hand operation request generated at time t30.

Thereafter, the hand operation request is not generated during the period of times t35 to t37, the period of times t45 to t47, and the period of times t53 to t55. Accordingly, the control unit 101 and the wireless communication control unit 111 perform the process the same as that during the period of times t24 to t26.

The hand operation request is generated in the hand operation permission period during the period of times t38 to t41 and the period of times t56 to t59. Accordingly, the control unit 101 and the wireless communication control unit 111 perform the process the same as that during the period of times t20 to t23.

The hand operation request is generated during the period of times t48 to t52 and in the communication period. Accordingly, the control unit 101 and the wireless communication control unit 111 perform the process the same as that during the period of times t30 to t34. That is, at the timing of time t51, the indicating hand control unit 1016 performs the hand operation request generated at time t49.

### Example of Process Procedure Performed by Control Unit 101

Next, a process procedure performed by the control unit 101 will be described.

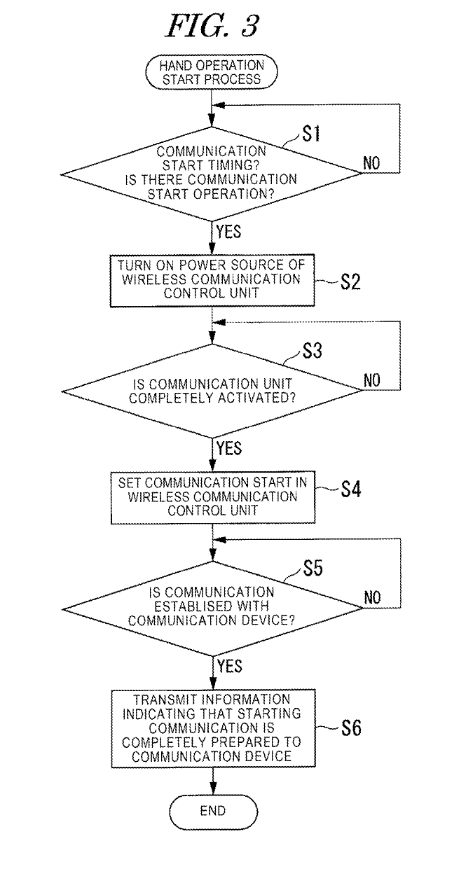

FIG. 3 is a flowchart of a main routine of the process performed by the control unit 101 according to the present embodiment.

(Step S1) A user operates the input unit 104 of the timepiece 100, and selects an operation mode for communicating with the communication device 200. Subsequently, based on an operation of the input unit 104, the communication control unit 1013 determines whether or not an instruction to start communication is received. Alternatively, the communication control unit 1013 determines whether or not the current time is the communication timing set in advance. For example, the communication timing set in advance is the timing at which the timepiece 100 receives time information transmitted by the communication device 200 and adjusts the time, and is every 24 hours, for example. The communication timing may be optionally set by the user operating the timepiece 100 or the communication device 200. In a case where the communication control unit 1013 determines not to start communication (Step S1; NO), the communication control unit 1013 repeatedly performs the process of Step S1. In a case where the communication control unit 1013 determines to start communication (Step S1; YES), the communication control unit 1013 proceeds to the process of Step S2.

(Step S2) The power supply control unit 1011 controls starting (turned-on state) of power supply to the wireless communication control unit 111.

(Step S3) The communication control unit 1013 determines whether or not the wireless communication control unit 111 is completely activated. In a case where the communication control unit 1013 determines that the wireless communication control unit 111 is not completely activated (Step S3; NO), the communication control unit 1013 repeatedly performs the process of Step S3. In a case where the communication control unit 1013 determines that the wireless communication control unit 111 is completely activated (Step S3; YES), the communication control unit 1013 proceeds to the process of Step S4. The communication control unit 1013 determines whether or not the wireless communication control unit 111 is activated, by determining whether a voltage value of a predetermined terminal of the wireless communication control unit 111 is equal to or greater than a threshold value. Alternatively, it is determined by transmitting a command to the wireless communication control unit 111 determining whether or not there is a response to the transmitted command.

(Step S4) The communication control unit 1013 sets to start communication with the wireless communication control unit 111. Subsequently, the communication control unit 1013 controls the wireless communication control unit 111 so as to start communication with the communication device 200. The communication establishment and communication procedures are based on the BLE communication standard.

(Step S5) The communication control unit 1013 determines whether or not communication with the communication device 200 is established. In a case where the communication control unit 1013 determines that communication with the communication device 200 is not established (Step S5; NO), the communication control unit 1013 repeatedly performs the process of Step S5. In a case where the communication control unit 1013 determines that communication with the communication device 200 is established (Step S5; YES), the communication control unit 1013 proceeds to the process of Step S6.

(Step S6) The communication control unit 1013 controls the information processing unit 1014 and the information transmission/reception unit 1015, and transmits information indicating that starting communication is completely prepared to the communication device 200.

Thereafter, the timepiece 100 transmits and receives information to and from the communication device 200 information until a communication disconnection request is received from the communication device 200.

Next, a process procedure of the hand operation permission setting during communication will be described.

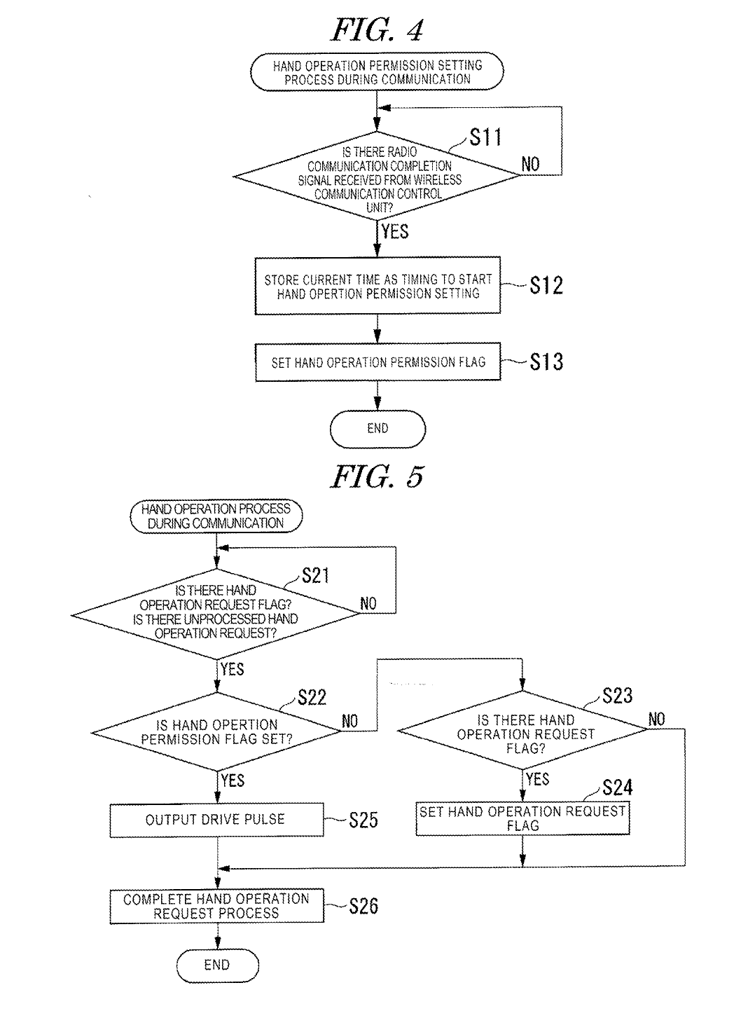

FIG. 4 is a flowchart of a hand operation permission setting process during communication according to the present embodiment.

(Step S11) The communication control unit 1013 determines whether or not the radio communication completion signal is received from the wireless communication control unit 111. In a case where the communication control unit 1013 determines that the radio communication completion signal is not received from the wireless communication control unit 111 (Step S11; NO), the communication control unit 1013 repeatedly performs the process of Step S11. In a case where the communication control unit 1013 determines that the radio communication completion signal is received from the wireless communication control unit 111 (Step S11; YES), the communication control unit 1013 proceeds to the process of Step S12.

(Step S12) The communication control unit 1013 causes the storage unit 105 to store the current time as the hand operation permission setting start timing. Subsequently, the communication control unit 1013 sets a predetermined time to T1 (FIG. 2) in a case of an advertisement state, and sets a predetermined time to T2 (FIG. 2) in a case of a connection state.

(Step S13) The communication control unit 1013 sets a hand operation permission flag, and causes the storage unit 105 to store the hand operation permission flag.

Next, a procedure of the hand operation process during communication will be described.

FIG. 5 is a flowchart of the hand operation process during communication according to the present embodiment.

(Step S21) The indicating hand control unit 1016 determines whether or not there is a hand operation request, and whether or not there is an unprocessed hand operation request. The indicating hand control unit 1016 determines that there is the unprocessed hand operation request in a case where the hand operation request flag is set in the storage unit 105. In a case where the indicating hand control unit 1016 determines that there is no hand operation request and there is no unprocessed hand operation request (Step S21; NO), the indicating hand control unit 1016 repeatedly performs the process of Step S21. In a case where the indicating hand control unit 1016 determines that there is the hand operation request or there is the unprocessed hand operation request (Step S21; YES), the indicating hand control unit 1016 proceeds to the process of Step S22.

(Step S22) The indicating hand control unit 1016 determines whether or not the hand operation permission flag is set in the storage unit 105. In a case where the indicating hand control unit 1016 determines that the hand operation permission flag is not set (Step S22; NO), the indicating hand control unit 1016 proceeds to the process of Step S23. In a case where the indicating hand control unit 1016 determines that the hand operation permission flag is set (Step S22; YES), the indicating hand control unit 1016 proceeds to the process of Step S25.

(Step S23) The indicating hand control unit 1016 determines whether or not there is the hand operation request. In a case where the indicating hand control unit 1016 determines that there is the hand operation request (Step S23; YES), the indicating hand control unit 1016 proceeds to the process of Step S24. In a case where the indicating hand control unit 1016 determines that there is no hand operation request (Step S23; NO), the indicating hand control unit 1016 proceeds to the process of Step S26.

(Step S24) The indicating hand control unit 1016 sets a hand operation request flag, and causes the storage unit 105 to store the hand operation request flag. After the process is performed, the indicating hand control unit 1016 proceeds to the process to Step S26.

(Step S25) The indicating hand control unit 1016 generates the drive pulse in response to the hand operation request, and outputs the generated drive pulse to the motor 122.

(Step S26) The indicating hand control unit 1016 completes the hand operation request process.

As illustrated in Steps S21 to S26 in FIG. 5, according to the present embodiment, it is determined whether or not the hand operation permission flag is set when the hand operation request is generated. If the hand operation permission flag is set, the hand operation is performed. If the hand operation permission flag is not set, the hand operation is not performed. In addition, according to the present embodiment, in a case where the hand operation request is generated in a period during which the hand operation permission flag is not set, the hand operation request flag is set, and the hand operation is performed during the subsequent hand operation permission period.

Next, a process of completing the communication between the timepiece 100 and the communication device 200 will be described.

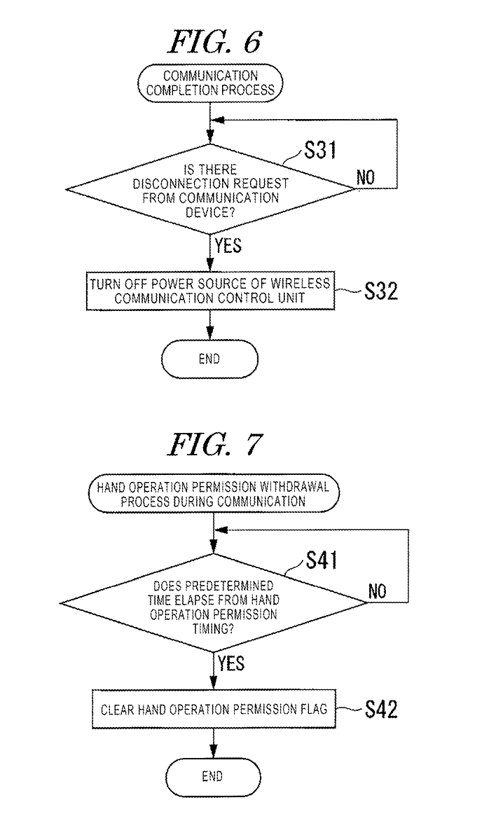

FIG. 6 is a flowchart of the process of completing the communication between the timepiece 100 and the communication device 200 according to the present embodiment.

(Step S31) The communication control unit 1013 determines whether or not there is a communication disconnection request from the communication device 200. In a case where the communication control unit 1013 determines that there is no communication disconnection request (Step S31; NO), the communication control unit 1013 repeatedly performs the process of Step S31. In a case where the communication control unit 1013 determines that there is the communication disconnection request (Step S31; YES), the communication control unit 1013 outputs information indicating that the communication disconnection request is received to the power supply control unit 1011, and the communication control unit 1013 proceeds to the process of Step S32.

(Step S32) The power supply control unit 1011 performs control so as to stop power supply (OFF; turned-off state) to the wireless communication control unit 111 in response to information indicating that the communication disconnection request is received output by the communication control unit 1013.

Through the above-described procedure, the communication with the communication device 200 is completed.

Next, a withdrawal process of the hand operation permission during communication will be described.

FIG. 7 is a flowchart of the withdrawal process of the hand operation permission during communication according to the present embodiment.

(Step S41) The communication control unit 1013 determines whether or not a predetermined time elapses from the hand operation permission timing, by determining whether or not it is the time obtained by adding the predetermined time to the time stored in Step S12 (FIG. 4). In a case where the communication control unit 1013 determines that the predetermined time does not elapse from the hand operation permission timing (Step S41; NO), the communication control unit 1013 repeatedly performs the process of Step S41. In a case where the communication control unit 1013 determines that the predetermined time elapses from the hand operation permission timing (Step S41; YES), the communication control unit 1013 proceeds to the process of Step S42.

(Step S42) The communication control unit 1013 clears the hand operation permission flag stored in the storage unit 105.

In the above-described example, an example has been described in which the current time is stored in Step S12 (FIG. 4) and the predetermined time is set depending on a state. However, the present invention is not limited thereto. The communication control unit 1013 may start a timer operation of the predetermined time, and may determine whether or not the predetermined time elapses in Step S41 (FIG. 7).

Next, a process of generating the hand operation timing during communication will be described.

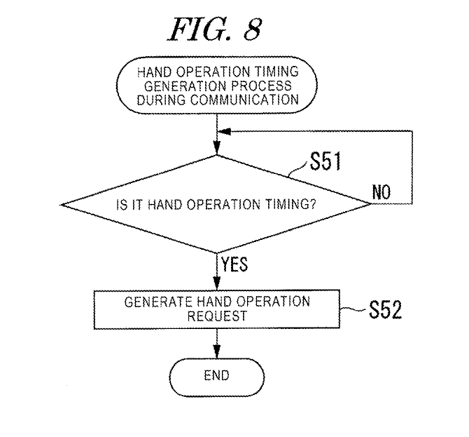

FIG. 8 is a flowchart of the process of generating the hand operation timing during communication according to the present embodiment.

(Step S51) Based on the reference signal, the indicating hand control unit 1016 determines whether or not it is the timing to perform the hand operation. In a case where the indicating hand control unit 1016 determines that it is not the timing to perform the hand operation (Step S51; NO), the indicating hand control unit 1016 repeatedly performs the process of Step S51. In a case where the indicating hand control unit 1016 determines that it is the timing to perform the hand operation (Step S51; YES), the indicating hand control unit 1016 proceeds to the process of Step S52.

(Step S52) The indicating hand control unit 1016 generates the hand operation request, based on the reference signal.

As described above, according to the present embodiment, in order to not affect the communication at each setting interval so as to ensure a stable communication state, a section (period) in which the motor 122 may be driven starting from each communication point is provided between the communication timings. That is, according to the present embodiment, the wireless communication control unit 111 outputs the radio wave output completion signal to the communication control unit 1013, when the wireless communication control unit 111 maintains the communication connection or completes the data transmission and reception process. The communication control unit 1013 and the indicating hand control unit 1016 receive the radio wave output completion signal when the indicating hand is driven. Thereafter, the motor 122 is permitted to be driven only for the predetermined time at which the hand operation permission flag is set. As described above, the predetermined time is a value corresponding to a communication state or a communication interval. According to the present embodiment, as illustrated in Step S5 (FIG. 3), the hand operation permission flag is not set during communication establishment (connection process state) with the communication device 200, and the motor 122 is prohibited from being driven. That is, according to the present embodiment, the wireless communication control unit 111 does not output the radio wave output completion signal during the connection process.

In this manner, according to the present embodiment, the indicating hand can be driven during communication.

In the timing chart of FIG. 2, an example has been described in which the motor 122 is not driven even if the hand operation request is generated excluding the hand operation permission period. Even in a case where this process is performed, the communication interval in the connection state is 150 msec, for example, and a hand operation permission period T2 is approximately 100 msec. Therefore, the control unit 101 can generate the hand operation request approximately six times per second. Accordingly, it is possible to receive the hand operation request approximately once every two times. Therefore, the second hand is not substantially hindered from being driven.

In this way, according to the present embodiment, the communication connection interval is maintained at a constant interval. Accordingly, the timing to output the radio communication completion signal is set as the starting point (start point) of the hand operation permission period during which the motor may be driven. In this manner, according to the present embodiment, even in a case where the wireless communication control unit 111 fails to receive the signal from the communication device 200, it is possible to avoid a risky situation in which outputting the radio wave and driving the motor are simultaneously performed, and it is possible to drive the indicating hand even during communication. In addition, according to the present embodiment, the communication connection interval is maintained at a desired constant interval without hindering the motor driving (driving of the indicating hand) in this way. Therefore, it is possible to ensure both a stable communication state and a stable driving of the indicating hand.

Furthermore, the present embodiment has an advantageous effect in a case where the hand operation request generation timing frequently occurs, that is, in a case of so-called fast-forward driving in which the driving speed is faster (or the driving frequency is higher) than that in the normal hand operation. That is, according to the present embodiment, even in a case where the hand operation request generation timing frequently occurs, the motor driving timing and the communication timing can be managed as intended according to the set hand operation permission period. Therefore, the both functions can be properly fulfilled.

### Second Embodiment

In the first embodiment, an example has been described in which the hand operation request is the information relating to time clocking. In the present embodiment, an example will be described in which the hand operation request is based on a communication state with the communication device 200.

In the second embodiment, a user selects a communication operation mode for performing communication by operating the input unit 104 of the timepiece 100. Then, as illustrated in FIG. 2, the timepiece 100 detects that the communication operation mode is selected, and performs each process in an advertisement state, in a connection establishment process state, and in a connection state. In the second embodiment, a communication state is indicated by a second hand 120A in each state of the advertisement state and the connection state.

A configuration of the timepiece 100 and the communication device 200 according to the present embodiment is the same as that according to the first embodiment. However, a process of the control unit 101 of the timepiece 100 is different therefrom.

In addition to the operation of the communication control unit 1013 described in the first embodiment, the communication control unit 1013 detects the communication state with the communication device 200, and outputs information indicating the detected communication state to the indicating hand control unit 1016. The communication state represents the advertisement state or a state where data transmission and reception are performed.

In addition to the operation of the indicating hand control unit 1016 described in the first embodiment, the indicating hand control unit 1016 generates the drive pulse for driving the second hand 120A in response to the information indicating the communication state output by the communication control unit 1013. A drive example of the second hand 120A will be described later.

### [Description of External Configuration of Timepiece 100]

Next, an example of an external configuration of the timepiece 100 according to the present embodiment will be described.

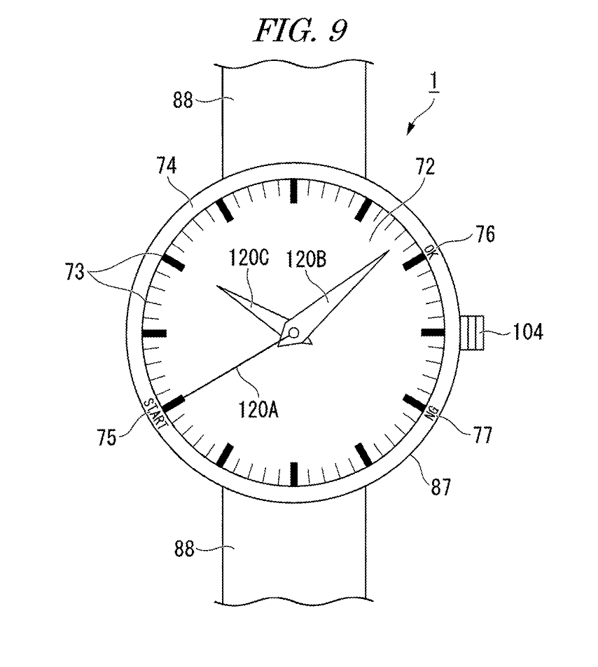

FIG. 9 is a view illustrating the example of the external configuration of the timepiece 100 according to the present embodiment.

As illustrated in FIG. 9, the timepiece 100 further includes a case 87 and a belt 88. The timepiece 100 includes configuration elements inside the case 87 except for the input unit 104 of the timepiece 100 illustrated in FIG. 1. In addition, the timepiece 100 includes a dial 72, a second hand 120A, a minute hand 120B, and an hour hand 120C which serve as a display unit. In the dial 72, an index bar (indicator) 73 is marked. The timepiece 100 includes a bezel 74 on the periphery of the dial 72.

A symbol of “START” is marked in the bezel 74 as a first mark 75, a symbol of “OK” is marked as a second mark 76, and a symbol of “NG” is marked as a third mark 77.

The symbol of “START” of the first mark 75 indicates that a mode for starting communication with the communication device 200 is set. The symbol of “OK” of the second mark 76 indicates that the communication with the communication device 200 is successful. The symbol of “NG” of the third mark 77 indicates that the communication with the communication device 200 fails.

In addition, the example illustrated in FIG. 9 shows a position of the second hand 120A when the communication starts after the timepiece 100 or the communication device 200 is operated by a user. As illustrated in FIG. 9, according to the present embodiment, the indicating hand control unit 1016 drives the second hand 120A to the position of “START” when the communication starts.

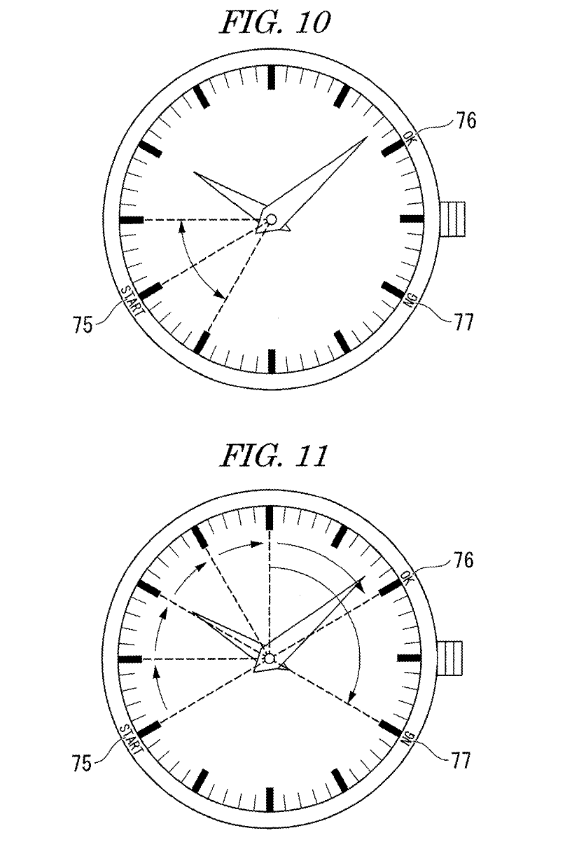

FIG. 10 is a view illustrating a drive example of the second hand 120A in the advertisement state according to the present embodiment.

As illustrated in FIG. 10, according to the present embodiment, in the advertisement state, the indicating hand control unit 1016 vibrates the second hand 120A in a range of ±5 seconds around the position of “START” so that the second hand 120A is driven to reciprocate every 5 seconds, for example. The indicating hand control unit 1016 drives the second hand 120A from the position of “START” to the position of 45 seconds, for example. Thereafter, the indicating hand control unit 1016 drives the second hand 120A from the position of 45 seconds to the position of “START”. Thereafter, the indicating hand control unit 1016 drives the second hand 120A from the position of “START” to the position of 35 seconds, and thereafter, the indicating hand control unit 1016 drives the second hand 120A from the position of 35 seconds to the position of “START”. Thereafter, the indicating hand control unit 1016 repeatedly performs the same process during the connection establishment process state. The indicating hand control unit 1016 generates the drive signal so that the hand operation is performed as many as the predetermined number of steps in order to cause the second hand 120A to perform the hand operation for 5 seconds.

FIG. 11 is a view illustrating a drive example of the second hand 120A in the connection state according to the present embodiment.

As illustrated in FIG. 11, according to the present embodiment, in the connection state, the indicating hand control unit 1016 drives the second hand 120A in a range from the position of “START” to the position of “OK”, for example, every time that predetermined data is received, for example, every 5 seconds. The indicating hand control unit 1016 drives the second hand 120A, for example, from the position of “START” to the position of 45 seconds. Thereafter, the indicating hand control unit 1016 drives the second hand 120A from the position of 45 seconds to the position of 50 seconds, then from the position of 50 seconds to the position of 55 seconds, and then from the position of 55 seconds to the position of 60 seconds.

In a case where there is no error during connection and the communication is successful without the communication being disconnected by the communication device 200, the indicating hand control unit 1016 drives the second hand 120A to the position of “OK”.

In a case where an error occurs during connection or the communication fails due to the communication disconnected by the communication device 200, the indicating hand control unit 1016 drives the second hand 120A to the position of “NG”.

Next, a process procedure of the control unit 101 will be described.

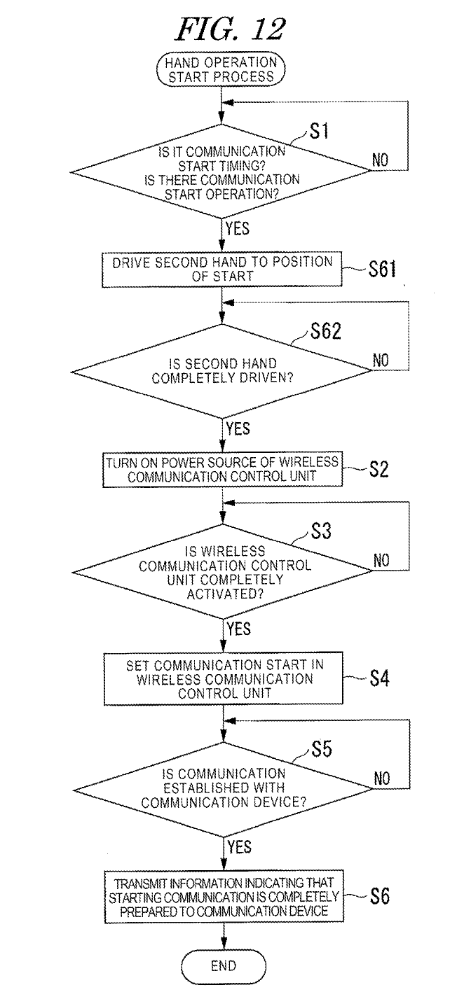

FIG. 12 is a flowchart of a main routine of the process performed by the control unit 101 according to the present embodiment.

(Step S1) The process of Step S1 is the same as that of Step S1 (FIG. 3) according to the first embodiment. After the process is performed, the control unit 101 proceeds to the process of Step S61.

(Step S61) As illustrated in FIG. 9, the indicating hand control unit 1016 drives the second hand 120A to the position of “START” during the hand operation permission period.

(Step S62) The indicating hand control unit 1016 determines whether or not the second hand 120A is completely driven to the position of “START”. In a case where the indicating hand control unit 1016 determines that the second hand 120A is not completely driven to the position of “START” (Step S62; NO), the indicating hand control unit 1016 repeatedly performs the process of Step S62. In a case where the indicating hand control unit 1016 determines that the second hand 120A is completely driven to the position of “START” (Step S62; YES), the indicating hand control unit 1016 proceeds to the process of Step S2.

(Steps S2 to S6) The control unit 101 performs process similarly to Steps S2 to S6 (FIG. 3).

The hand operation permission setting process during communication is the same as that in Steps S11 to S13 (FIG. 4) according to the first embodiment.

Next, a hand operation process of the second hand 120A in the advertisement state will be described.

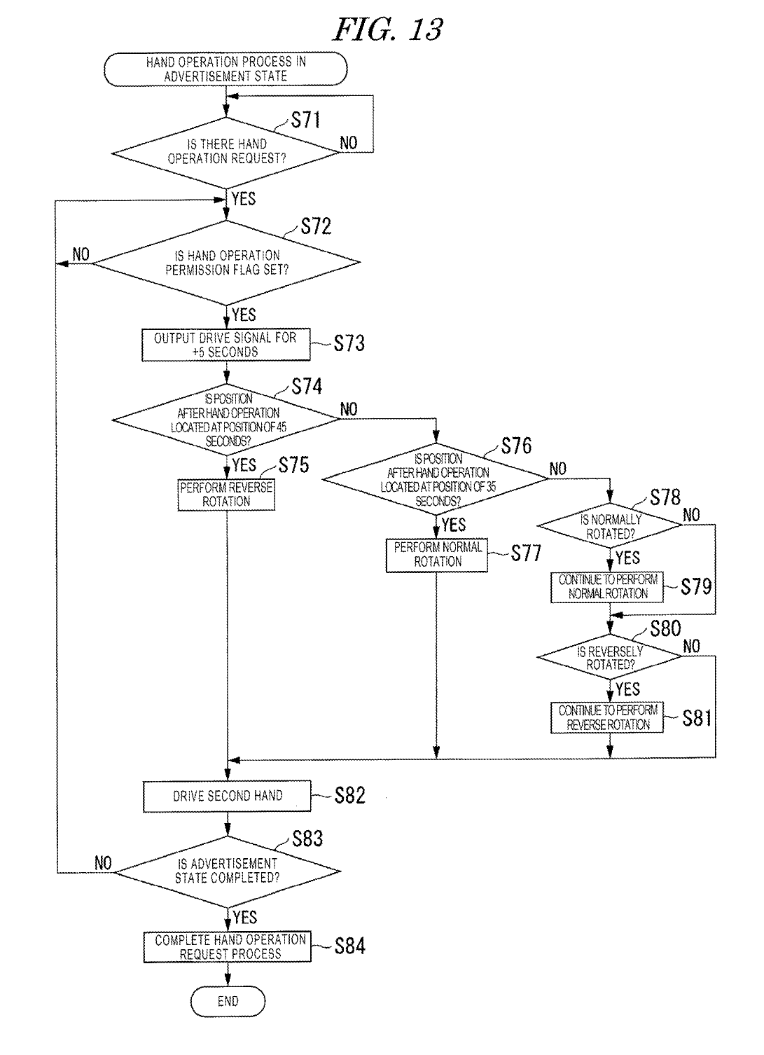

FIG. 13 is a flowchart of the hand operation process of the second hand 120A in the advertisement state according to the present embodiment.

(Step S71) The indicating hand control unit 1016 determines whether or not there is the hand operation request. In a case where the indicating hand control unit 1016 determines that there is no hand operation request for the second hand 120A (Step S71; NO), the indicating hand control unit 1016 repeatedly performs the process of Step S71. In a case where the indicating hand control unit 1016 determines that there is the hand operation request (Step S71; YES), the indicating hand control unit 1016 proceeds to the process of Step S72.

(Step S72) The indicating hand control unit 1016 determines whether or not the hand operation permission flag is set in the storage unit 105. In a case where the indicating hand control unit 1016 determines that the hand operation permission flag is set (Step S72; YES), the indicating hand control unit 1016 proceeds to the process of Step S73. In a case where the indicating hand control unit 1016 determines that the hand operation permission flag is not set (Step S72; NO), the hand operation request flag is set, and the process of Step S72 is repeatedly performed. In this case, the indicating hand control unit 1016 performs the hand operation request, for example, after 32 Hz (after approximately 31 msec), during the period while the hand operation permission flag is set.

(Step S73) The indicating hand control unit 1016 generates the drive pulse for +5 seconds in response to the indicating hand request, and outputs the generated drive pulse to the stepping motor 122A.

(Step S74) The indicating hand control unit 1016 determines whether or not the position of the second hand 120A is located at the position of 45 seconds. In a case where the indicating hand control unit 1016 determines that the position of the second hand 120A is located at the position of 45 seconds (Step S74; YES), the indicating hand control unit 1016 proceeds to the process of Step S75. In a case where the indicating hand control unit 1016 determines that the position of the second hand 120A is not located at the position of 45 seconds (Step S74; NO), the indicating hand control unit 1016 proceeds to the process of Step S76. The indicating hand control unit 1016 causes the storage unit 105 to store the counted value indicating each position of the indicating hand 120, based on the number of steps used in driving the indicating hand 120. For example, the indicating hand control unit 1016 adds 1 in a case where the indicating hand performs one step normal rotation. The indicating hand control unit 1016 subtracts 1 in a case where the indicating hand performs one step reverse rotation.

(Step S75) The indicating hand control unit 1016 sets the second hand 120A to perform reverse rotation. After the setting, the indicating hand control unit 1016 proceeds to the process of Step S82.

(Step S76) The indicating hand control unit 1016 determines whether or not the position of the second hand 120A is located at the position of 35 seconds. In a case where the indicating hand control unit 1016 determines that the position of the second hand 120A is located at the position of 35 seconds (Step S76; YES), the indicating hand control unit 1016 proceeds to the process of Step S77. In a case where the indicating hand control unit 1016 determines that the position of the second hand 120A is not located at the position of 35 seconds (Step S76; NO), the indicating hand control unit 1016 proceeds to the process of Step S78.

(Step S77) The indicating hand control unit 1016 sets the second hand 120A to perform normal rotation. After the setting, the indicating hand control unit 1016 proceeds to the process of Step S82.

(Step S78) The indicating hand control unit 1016 determines whether or not the hand operation of the second hand 120A is normal rotation. In a case where the indicating hand control unit 1016 determines that the hand operation is the normal rotation (Step S78; YES), the indicating hand control unit 1016 proceeds to the process of Step S79. In a case where the indicating hand control unit 1016 determines that the hand operation is not the normal rotation (Step S78; NO), the indicating hand control unit 1016 proceeds to the process of Step S80.

(Step S79) The indicating hand control unit 1016 sets the second hand 120A so as to continuously perform the normal rotation. After the setting, the indicating hand control unit 1016 proceeds to the process of Step S80.

(Step S80) The indicating hand control unit 1016 determines whether or not the hand operation of the second hand 120A is reverse rotation. In a case where the indicating hand control unit 1016 determines that the hand operation is the reverse rotation (Step S80; YES), the indicating hand control unit 1016 proceeds to the process of Step S81. In a case where the indicating hand control unit 1016 determines that the hand operation is not the reverse rotation (Step S80; NO), the indicating hand control unit 1016 proceeds to the process of Step S82.

(Step S81) The indicating hand control unit 1016 sets the second hand 120A so as to continuously perform the reverse rotation. After the setting, the indicating hand control unit 1016 proceeds to the process of Step S82.

(Step S82) The indicating hand control unit 1016 drives the second hand 120A.

(Step S83) The communication control unit 1013 determines whether or not the advertisement state is completed. In a case where the communication control unit 1013 determines that the advertisement state is completed (Step S83; YES), the communication control unit 1013 proceeds to the process of Step S84. In a case where the communication control unit 1013 determines that the advertisement state is not completed (Step S83; NO), the communication control unit 1013 returns the process to Step S72.

(Step S84) The control unit 101 completes the hand operation request process.

Through the processes of Steps S71 to S84, the hand operation illustrated in FIG. 10 is performed.

Next, a hand operation start process in a connection state will be described.

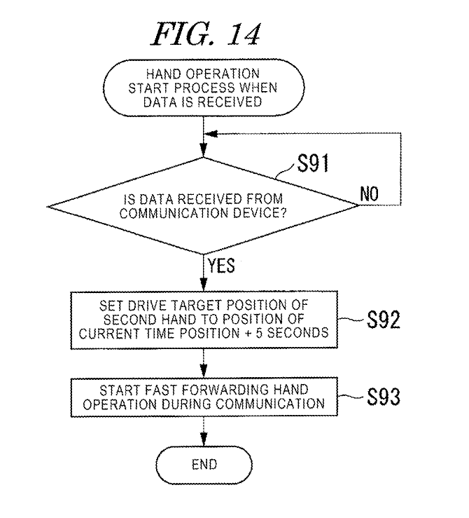

FIG. 14 is a flowchart of the hand operation start process in the connection state according to the present embodiment.

(Step S91) The communication control unit 1013 determines whether or not the information transmission/reception unit 1015 receives a predetermined amount of data from the communication device 200. In a case where the communication control unit 1013 determines that the predetermined amount of data is not received (Step S91; NO), the communication control unit 1013 repeatedly performs the process of Step S91. In a case where the communication control unit 1013 determines that the predetermined amount of data is received (Step S91; YES), the communication control unit 1013 proceeds to the process of Step S92.

(Step S92) The communication control unit 1013 sets a drive target position of the second hand 120A to a position of the current time position +5 seconds.

(Step S93) the communication control unit 1013 generates the drive pulse, and starts a fast forwarding hand operation during communication in the hand operation permission period. The fast forwarding hand operation is the hand operation which causes the second hand 120A to move forward every 5 seconds, for example.

Next, a processing at the time of communication completion will be described.

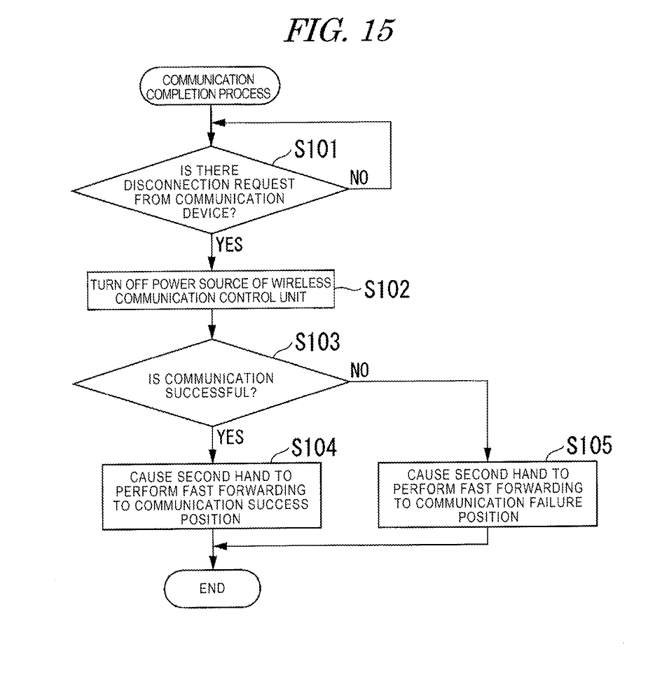

FIG. 15 is a flowchart of the process at the time of communication completion according to the present embodiment.

(Step S101) The communication control unit 1013 determines whether or not the information transmission/reception unit 1015 receives a communication disconnection request from the communication device 200, that is, whether or not there is a communication disconnection request. In a case where the communication control unit 1013 determines that there is no communication disconnection request (Step S101; NO), the communication control unit 1013 repeatedly performs the process of Step S101. In a case where the communication control unit 1013 determines that there is the communication disconnection request (Step S101; YES), the communication control unit 1013 proceeds to the process of Step S102.

(Step S102) The communication control unit 1013 performs control so as to stop (turn off) the power supply to the wireless communication control unit 111 after the communication with the communication device 200 is completed.

(Step S103) The communication control unit 1013 determines whether or not the communication with the communication device 200 is successful. In a case where the communication control unit 1013 determines that the communication with the communication device 200 is successful (Step S103; YES), the communication control unit 1013 proceeds to the process of Step S104. In a case where the communication control unit 1013 determines that the communication with the communication device 200 fails (Step S103; NO), the communication control unit 1013 proceeds to the process of Step S105.

(Step S104) The indicating hand control unit 1016 causes the second hand 120A to perform fast forwarding drive to the position of “OK” (FIG. 11) which is a communication success position during the hand operation permission period. After the process is performed, the indicating hand control unit 1016 completes the communication with the communication device 200.

(Step S105) The indicating hand control unit 1016 causes the second hand 120A to perform fast forwarding drive to the position of “NG” (FIG. 11) which is a communication failure position during the hand operation permission period. After the process is performed, the indicating hand control unit 1016 completes the communication with the communication device 200.

As described above, according to the present embodiment, even in the advertisement state or the communication state, the communication state is displayed during the hand operation permission period, and the second hand 120A is driven so as to display the communication state. In this manner, a user can recognize the communication state between the timepiece 100 and the communication device 200 by using the movement of the second hand 120A.

In the present embodiment, an example has been described in which the communication state is displayed by causing the second hand 120A to perform the hand operation. However, the present invention is not limited thereto. For example, in a case where the timepiece 100 has a chronograph function (stopwatch function) or a world timepiece function and has four or more indicating hands 120, the indicating hand control unit 1016 may display the communication state by driving the indicating hands 120 corresponding to the functions.

In addition, in the first embodiment, an example has been described in which the hand operation relating to time clocking is performed during the hand operation permission period. In the second embodiment, an example has been described in which the hand operation relating to the communication state is performed. However, the present invention is not limited thereto. The hand operation performed during the hand operation permission period may be a hand operation relating to a chronograph operation, a hand operation relating to a timer operation, a hand operation relating to an alarm operation, a hand operation corresponding to a request from the communication device 200.

In addition, in the first embodiment and the second embodiment, an example has been described in which the wireless communication control unit 111 generates and outputs the radio communication completion signal to the communication control unit 1013. However, the present invention is not limited thereto. For example, the communication control unit 1013 may control the wireless communication control unit 111 so as to perform communication. In this case, the communication control unit 1013 may generate the radio communication completion signal by itself. In addition, the communication control unit 1013 may determine the communication state by itself.

A program for partially or entirely realizing the functions of the control unit 101 or the wireless communication control unit 111 according to the present invention may be recorded on a computer-readable recording medium, and the program recorded on the recording medium may be read and executed by a computer system. In this manner, the process performed by the control unit 101 or the wireless communication control unit 111 may be perform. The “computer system” described herein includes hardware such as an OS and peripheral devices. In addition, the “computer system” also includes a WWW system provided with a homepage providing environment (or display environment). In addition, the “computer-readable recording medium” means a storage device such as a portable medium such as a flexible disk, a magneto-optical disk, a ROM, and a CD-ROM, or a hard disk incorporated in the computer system. Furthermore, the “computer-readable recording medium” includes those which hold a program for a certain period of time such as a volatile memory (RAM) inside the computer system serving as a server or a client in a case where the program is transmitted via a network using the Internet or a communication line such as a telephone line.

In addition, the above-described program may be transmitted from the computer system having the program stored in a storage device to another computer system via a transmission medium. Alternatively, the program may be transmitted to another computer system by using a transmission wave in the transmission medium. Here, the “transmission medium” for transmitting the program may be a medium having a function to transmit information, such as the network (communication network) using the Internet or the communication line (communication cable) such as the telephone line. In addition, the above-described program may be used for partially realizing the above-described functions. Furthermore, the above-described program may be a so-called difference file (differential program) which can realize the above-described functions in combination with the program previously recorded in the computer system.

What is claimed is:

1. A timepiece comprising:
a communication unit that controls communication with a communication device by using a periodic communication radio wave; and
a control unit that controls a hand operation of an indicating hand driven by a motor,
wherein the control unit sets a hand operation permission period during which the hand operation of the indicating hand is permitted starting from communication timing of the communication radio wave.

2. The timepiece according to claim 1,
wherein the communication unit outputs a radio communication completion signal indicating that the communication timing of the communication radio wave is completed, and
wherein the control unit sets the hand operation permission period when receiving the radio communication completion signal, and drives the motor during the hand operation permission period.

3. The timepiece according to claim 1,
wherein the hand operation permission period is set as a first permission period in a case where the communication timing of the communication radio wave is a first period, and
wherein the hand operation permission period is set as a second permission period shorter than the first permission period in a case where the communication timing of the communication radio wave is a second period shorter than the first period.

4. The timepiece according to claim 1,
wherein the communication unit detects at least one of communication states including a state of searching for the communication device, a state of performing a connection process for communication with the communication device, and a state of enabling data communication with the communication device, and
wherein the control unit changes the hand operation permission period in response to the communication state detected by the communication unit.

5. The timepiece according to claim 1,
wherein the control unit does not set the hand operation permission period in the state of performing the connection process for communication with the communication device.

6. The timepiece according to claim 2,
wherein the communication unit does not output the radio communication completion signal in the state of performing the connection process for communication with the communication device.

7. The timepiece according to claim 1,
wherein when there is a hand operation request for requesting the hand operation of the indicating hand, the control unit determines whether or not the requesting time is the hand operation permission period,
wherein in a case where the requesting time is the hand operation permission period, the control unit performs control so that the motor is driven in response to the hand operation request, and
wherein in a case where the requesting time is not the hand operation permission period, the control unit performs control so that the motor is not driven in response to the hand operation request.

8. The timepiece according to claim 1,
wherein when there is a hand operation request for requesting the hand operation of the indicating hand, the control unit determines whether or not the requesting time is the hand operation permission period,
wherein in a case where the requesting time is the hand operation permission period, the control unit performs control so that the motor is driven in response to the hand operation request, and
wherein in a case where the requesting time is not the hand operation permission period, after the elapse of time correction, the control unit determines whether or not the requesting time is the hand operation permission period.

9. The timepiece according to claim 1,
wherein during the hand operation permission period, the control unit causes the indicating hand to perform the hand operation so that as a communication state, the communication unit uses a motion of the indicating hand to notify at least one state among a state of searching for the communication device, a state of performing a connection process for communication with the communication device, and a state of enabling data communication with the communication device.

10. The timepiece according to claim 1,
wherein when data is received in the state of enabling data communication with the communication device, during the hand operation permission period, the control unit causes the indicating hand to perform the hand operation as many as the predetermined number of steps so that a communication progress status of the data is notified using the hand operation performed as many as the predetermined number of steps which reflects the communication progress status of the data.

11. The timepiece according to claim 1, further comprising:
an operation unit that selects any one function among a time display function, a timer function, an alarm function, and a stopwatch function,
wherein in a case where the indicating hand is driven based on the function selected by operating the operation unit, during the hand operation permission period, the control unit causes the indicating hand to perform the hand operation so that a position of the indicating hand is updated to an updated position corresponding to the function.

12. A control method of a timepiece which has a control unit for controlling a hand operation of an indicating hand driven by a motor, the control method comprising:
causing a communication unit to control communication with a communication device by using a periodic communication radio wave;
causing the communication unit to output a radio communication completion signal indicating that communication timing of the communication radio wave is completed;
causing the control unit to set a hand operation permission period during which the hand operation of the indicating hand is permitted starting from the communication timing of the communication radio wave; and
causing the control unit to set the hand operation permission period when the radio communication completion signal is received, and to drive the motor during the hand operation permission period.

13. A timepiece comprising:
a communication unit configured to control communication with a communication device via a series of periodic communication radio waves; and
a control unit configured to control a hand operation of an indicating hand driven by a motor, the control unit being configured to set a hand operation permission period for permitting the indicating hand to be operated the hand operation, the hand operation permission period being configured to be set starting from each time point of the series of periodic communication radio waves, the hand operation permission period being configured to be set as being shorter than an interval period between consecutive two waves of the series of periodic communication radio waves.
